(19) United States
(12) Patent Application Publication
(10) Pub. No.: US 2008/0078486 A1
(43) Pub. Date: Apr. 3, 2008

(54) Gas generating system and composition

(76) Inventors: Paresh S. Khandhadia, Troy, MI (US); Hideki Mizuno, Rochester Hills, MI (US)

Correspondence Address: L.C. Begin & Associates, PLLC, 510 Highland Avenue, PMB 403, Milford, MI, 48381, US

(21) Appl. No.: 11/906,348

(22) Filed: Oct. 1, 2007

Related U.S. Application Data
(60) Provisional application No. 60/848,682, filed on Sep. 30, 2006.

(51) Int. Cl. B60R 21/16

(52) U.S. Cl. 149/109.2; 149/109.4

(57) ABSTRACT

A gas generating system devoid of a booster chamber. The inflator includes a composition having a metal chlorate as a first oxidizer, a primary fuel selected from carboxylic acids, dicarboxylic acids, and mixtures thereof, and a second oxidizer not having perchlorate character. The metal chlorate is provided at about 10-20 wt %, the primary fuel is provided at about 15-45 wt %, and the second oxidizer is provided at about 30-50 wt % stated by weight of the total composition.

### CROSS-REFERENCE TO RELATED APPLICATIONS

This application claims the benefit of U.S. Provisional Application Ser. No. 60/848,682 filed on Sep. 30, 2006.

### BACKGROUND OF THE INVENTION

The present invention relates generally to gas generating systems, and to gas generant compositions employed in gas generator devices for automotive restraint systems, for example.

As known in the art, gas generating systems may be used for providing a supply of inflation or actuation gas to a gas-actuated element of a vehicle occupant protection system. An ongoing challenge is to simplify the manufacture of a gas generating system by reducing the size, weight, and number of constituents required in the production thereof. For example, in many gas generators used in vehicle occupant protection systems, several discrete compositions are provided to serve correspondingly discrete functions. These compositions often include a primary gas generating composition that when combusted provides sufficient quantities of gaseous products to operate an associated restraint device, such as an airbag or seatbelt pretensioner.

A booster composition is utilized to elevate the pressure and heat within the gas generator prior to combustion of the primary gas generant, thereby creating conditions within the inflator which facilitate efficient combustion of the primary gas generant.

Yet another composition is an auto-ignition composition employed to provide safe combustion of the other compositions in the event of a fire. The auto-ignition composition is designed to ignite at temperatures below the melting point of the primary gas generant for example, thereby ensuring the controlled combustion of the primary gas generant. Ignition of the autoignition composition provides the flame front and pressure front necessary to safely ignite a gas generant composition residing in combustible communication with the autoignition composition. As a result, the main gas generant is safely ignited prior to melting.

However, while each separate composition contributes to efficient and effective operation of the gas generating system, each composition also adds weight, cost (in materials and assembly time), and volume to the system. For example, to facilitate operation of each composition and to prevent mixing between the various compositions, the booster composition, gas generant, and autoignition compositions are typically stored in separate tubes or chambers. Provision of a separate storage chamber for each composition generally adds to the weight, cost, and assembly time needed to construct the gas generating system. In addition, if a relatively greater the amount of combustible material is burned during operation of the system, a correspondingly greater amount of effluent and heat will be usually generated by the burning of the material. Therefore, it would be advantageous to reduce the number of gas generating system components and the number of compositions used in the operation of the system.

### SUMMARY OF THE INVENTION

The above-referenced concerns and others may be resolved by gas generating systems including a gas generant composition containing a first oxidizer selected from metal chlorates, such as potassium chlorate, a carboxylic acid or dicarboxylic acid as a primary fuel, a secondary oxidizer selected from metal and nonmetal nitrates, nitrites, oxides, basic metal nitrates, and other known oxidizers, and an optional secondary fuel selected from azoles including tetrazoles, triazoles, and furazans, and salts thereof. Other constituents including extrusion aids, such as fumed silica and/or graphite, may be included in relatively small amounts.

In further accordance with the present invention, a gas generator and a vehicle occupant protection system incorporating the gas generant/booster composition are also included. Novel gas generant formulations as described herein perform the functions of both the gas generant and booster compositions. Alternatively, the gas generant formulations described herein may perform the functions of the gas generant, booster, and autoignition compositions. In view of the multifunctional benefit of the gas generating composition, the booster and/or autoignition materials and the structure defining the chambers for containing the booster and/or autoignition materials may be eliminated, thereby simplifying the manufacture of the inflator.

### BRIEF DESCRIPTION OF THE DRAWINGS

FIG. 1 is a cross-sectional side view showing the general structure of a conventional gas generating system incorporating separate booster and gas generating chambers;

FIG. 2 is a cross-sectional side view showing the general structure of a gas generating system in accordance with the present invention, in which the booster chamber has been eliminated;

FIG. 3 is a schematic representation of an exemplary vehicle occupant restraint system containing a gas generant composition in accordance with the present invention; and

FIG. 4 is a cross-sectional side view showing the general structure of a gas generating system in accordance with an alternative embodiment of the present invention, in which the booster chamber has been eliminated.

### DETAILED DESCRIPTION

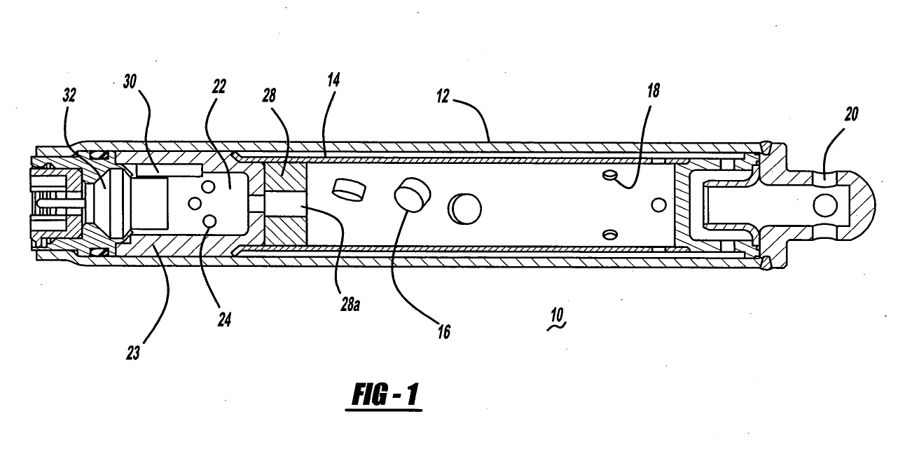

FIG. 1 shows a cross-section of a conventional gas generating system 10 incorporating separate booster and gas generating chambers therein. The embodiments of the gas generating system shown in FIGS. 1, 2, and 4 are in the form of inflators usable for inflating associated elements of a vehicle occupant protection system, for example. However, such gas generating systems may also be used in other applications. The structure and operation of the basic system components described herein is known in the art. In addition, the materials and techniques used in manufacturing the structural components of the gas generating system are known in the art.

System 10 includes an outer housing 12 and an inner housing 14 positioned within the outer housing and containing a quantity of gas generant material 16 therein. Inner housing 14 defines a combustion chamber for the gas generant. Inner housing orifices 18 provide fluid communication between the interior and exterior of inner housing 14. A fluid flow path is provided within housing 12 and between orifices 18 and gas exit openings 20 formed in an end or other portion of housing 12. A booster chamber 22 is formed by a booster cup 23 and a divider 28. Chamber 22 houses a booster composition 24 therein. Divider 28 separates booster composition 24 from gas generant 16 and enables fluid communication (via opening 28a) between the booster chamber and the combustion chamber upon activation of the gas generating system and combustion of the booster composition. As used herein, the term “booster chamber” is understood to designate any structure and/or components which perform the function of separating the booster composition from the gas generant composition. An initiator 32 is provided for initiating combustion of booster composition 24 upon receipt of an activation signal, in a manner known in the art. An autoignition material 30 is positioned so as to provide or enable fluid communication with the booster composition 24 upon exposure of the system to an elevated external temperature (such as that produced by a fire, for example) sufficient to cause ignition of the autoignition material.

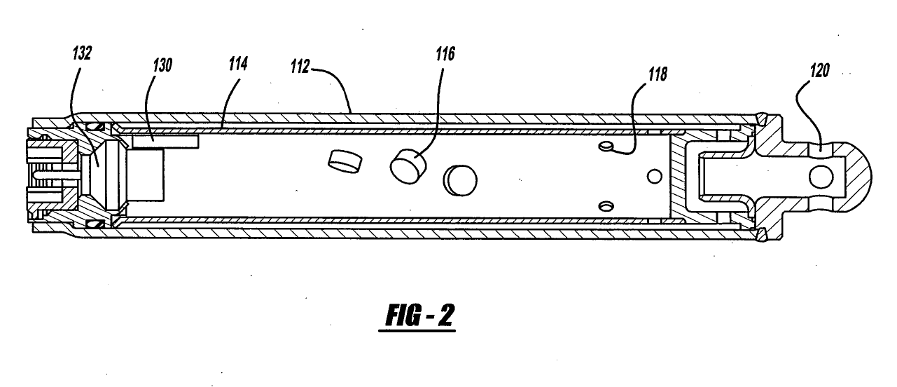

FIG. 2 shows a cross-sectional side view showing the general structure of a gas generating system 100 in accordance with the present invention. Components common to the systems shown in FIGS. 1, 2, and 4 have been given similar element numbers for simplicity and clarity. It may be seen from a comparison of FIGS. 1 and 2 that the separate booster composition 24 and booster chamber 22 shown in FIG. 1 have been eliminated in the system shown in FIG. 2. This is accomplished through the use of a gas generant composition 116 in accordance with one of the embodiments described herein. Such compositions perform the functions of both gas generant and booster compositions, or the functions of gas generant, booster, and autoignition compositions, thereby eliminating the need for separate compositions and the structure (such as the booster cup and divider) needed to separate and support the separate compositions. This reduces system weight and enables the length of the system envelope to be shortened. Where a gas generant is formulated which serves the functions of only gas generant and booster compositions, a separate autoignition composition may still be provided in an appropriate location within the gas generating system to ensure safe actuation of the system in case of fire, as previously described.

In one embodiment, gas generant compositions in accordance with the present invention contain a first oxidizer selected from alkali, alkaline earth, and transitional metal chlorates, and mixtures thereof, such as potassium chlorate, at about 10-60 weight %; a primary fuel selected from carboxylic acids and dicarboxylic acids, such as DL-tartaric acid, at about 15-45 weight %; a secondary oxidizer selected from metal and nonmetal nitrates, nitrites, oxides, and other known oxidizers at about 30-50%; and a secondary fuel selected from tetrazoles, triazoles, furazans, and salts thereof at about 0-30 weight %, said weight percent calculated with regard to the weight of the total composition. Extrusion aids or processing additives such as graphite or fumed silica may be added in relatively smaller amounts, such as 0.1-2% by weight of the total composition for example.

In another embodiment, gas generant compositions in accordance with the present invention contain a metal chlorate such as potassium chlorate; a primary fuel selected from carboxylic acids and dicarboxylic including DL-tartaric acid, L-tartaric acid, D-tartaric acid, succinic acid, glutamic acid, adipic acid, mucic acid, fumaric acid, oxalic acid, galactaric acid, citric acid, glycolic acid, L-malic acid, and compounds having at least one —COOH— group, and mixtures thereof; a second fuel selected from an azole including tetrazoles, triazoles, furazans, salts thereof, and mixtures thereof; a secondary oxidizer selected from metal and nonmetal nitrates or other known oxidizers not containing a perchlorate. However, it will be appreciated that any composition that provides the multifunctional benefits of gas generant, booster, and (optionally) autoignition is contemplated.

The carboxylic acid or dicarboxylic acid will preferably have a primary hydrogen or PKA less than or equal to 3. Nevertheless, it has been found that with certain fuels/salts, the pKa of the base acid may range up to 5.0 or less.

In a particular embodiment, the total fuel constituent including the carboxylic fuel and the second fuel is provided at about 20-45% by weight of the total composition; the oxidizer constituent is provided at about 20-50% by weight of the total composition; and the potassium chlorate or metal chlorate is provided at about 10-60% by weight of the total composition wherein the weight percent of the chlorate is separately calculated from that of the oxidizer. The composition may be formed by wet or dry mixing the constituents in a granulated form in a known manner, and then pelletizing or otherwise forming the composition for further use. The constituents may be provided by Fisher Chemical, Aldrich Chemical, GFS, and other known suppliers.

Embodiments of the present invention are exemplified by the following Examples:

### COMPARATIVE EXAMPLE 1

A known gas generant composition was prepared by homogeneously mixing dried and granulated D-glucose at about 26.875 wt % and potassium chlorate at about 73.125 wt %, the percents stated by weight of the total composition. The composition autoignited at about 144° C. as measured by DSC analysis. The propellant formed from the constituents resulted in an approximate 55.5% gas yield. The impact sensitivity of this formulation had an HD50 of 2.0 inches as conducted in conformance with the Bruceton Test.

### EXAMPLE 2

An exemplary formulation was provided that functions as a booster, an autoignition composition, and a gas generant composition. The formulation contains 5-aminotetrazole at about 19.0 wt %, DL-tartaric acid at about 20.0 wt %, strontium nitrate at about 35.0 wt %, and potassium chlorate at about 26.0 wt %. The constituents were previously and separately ground to a relatively small size in a known manner. They were then dry-mixed to form a substantially homogeneous composition. The composition autoignited at about 140° C. as measured by DSC analysis. The propellant formed from the constituents resulted in an approximate 67% gas yield. The impact sensitivity of this formulation had an HD50 of 11.5 inches as conducted in conformance with the Bruceton Test. The composition was aged for about 480 hours at 107 C and still autoignited at about 145.1° C. as determined by DSC analysis.

### EXAMPLE 3

An exemplary formulation was provided that functions as a booster, an autoignition, and a gas generant composition. The formulation contains 5-aminotetrazole at about 19.0 wt %, DL-tartaric acid at about 19.0 wt %, strontium nitrate at about 50.0 wt %, and potassium chlorate at about 12.0 wt %. The constituents were granulated and dry-mixed to form a substantially homogeneous composition. The composition autoignited at about 141° C. as measured by DSC analysis. The propellant formed from the constituents resulted in an approximate 68.2% gas yield. The impact sensitivity of this formulation had an HD50 of 8.8 inches as conducted in conformance with the Bruceton Test. As shown in FIG. 3, the composition reflected a relatively strong burn rate across several pressure regimes, and in particular indicated burn rates of over 0.8 inches per second (ips). Again referring to FIG. 3, it can be seen that the composition exhibited a burn rate of about 0.2 ips at about 200 psig, about 0.35 ips at about 550 psig, about 0.5 ips at about 1000 psig, about 0.55 ips at about 1500 psig, about 0.85 ips at about 2000 psig, about 0.9 ips at about 2500 psig, about 0.85 ips at about 3000 psig; and about 1.2 ips at about 3900 psig. It can therefore be seen that a composition in accordance with the present invention exhibits a satisfactory burn rate (typically 0.4 ips or more at about 2500-3000 psig) thereby ensuring satisfactory functionality as a primary gas generant. The composition was aged for about 480 hours at 107° C. and still autoignited at about 174.7° C. as determined by DSC analysis.

### EXAMPLE 4

An exemplary formulation was provided that functions as a booster, an autoignition, and a gas generant composition. The formulation contains DL-tartaric acid at about 28.0 wt %, strontium nitrate at about 32.0 wt %, and potassium chlorate at about 30.0 wt % and 10% of a secondary fuel. The constituents were previously and separately ground to a relatively small size in a known manner. They were then dry-mixed to form a substantially homogeneous composition. The composition autoignited at about 153° C. as measured by DSC analysis. The propellant formed from the constituents resulted in an approximate 66.1% gas yield. The impact sensitivity of this formulation had an HD50 of 8.1 inches as conducted in conformance with the Bruceton Test.

As indicated in Examples 1-4, compositions formed in accordance with the present invention (Examples 2-4) preferably autoignite at or below about 180° C. and provide a booster function as well. The compositions of the present invention may also produce substantial quantities of gas, and exhibit sufficient burn rates thereby producing sufficient amounts of gas when activated. Compositions employing a secondary oxidizer, such as strontium nitrate, provide relative increased quantities of gas and an improved sensitivity. A Bruceton sensitivity result wherein H₅₀=3.9 or more relaxes the packaging requirements as per U.S.D.O.T regulations. Accordingly, compositions having a sensitivity result of 3.9 or greater provide substantial packaging advantages. It will further be appreciated that the use of a secondary fuel, such as 5-aminotetrazole, in conjunction with the carboxylic or dicarboxylic acid, the secondary oxidizer, and the potassium chlorate produces greater amounts of gas, acceptable autoignition temperatures, and booster functionality. As such, compositions formed in this manner may be provided to singularly replace the three discrete booster, autoignition, and primary gas generant compositions normally found in a gas generator.

### EXAMPLES 5-16

As shown in Table 1 below, the various acids shown, when converted to salts and mixed with potassium chlorate in stoichiometric amounts exhibit acceptable autoignition temperatures for a variety of uses. Certain autoignition temperatures exceed 180° C. but may still be useful in selected applications such as hybrid inflators and seatbelt pretensioners for example. It will be appreciated that these Examples reflect the autoignition character imparted by the resulting salts and the potassium chlorate. As further shown, acids exhibiting a pKa of about 3.05 or less generally provide autoignition temperatures generally less than 170-180° C. However, acids exhibiting a pKa of about 5.0 or less may still be acceptable wherein autoignition temperatures of 250° C. or so are acceptable, for example. It will be appreciated that certain acids such as citric acid and malonic acid when stoichiometrically combined with potassium chlorate may not satisfy the autoignition function, but still when combined with at least a second oxidizer function as a booster oxidizer and a primary gas generant. It has further been determined that the use of a desiccant as described in co-owned and co-pending U.S. Ser. No. 11/479,493, herein incorporated by reference, may in certain circumstances maintain optimum environmental conditions within the gas generator thereby facilitating the tri-functionality of the composition when used as an autoignition, booster, and primary gas generating composition.

TABLE 1

| | | | Stoichiometric Mixture w | | |
|---|---|---|---|---|---|
| | | | KC | | |
| | | Lit. | | Hot | |
| Name | Structure | mp | DSC/TGA | Plate | PKa |
| L-Tartaric Acid | 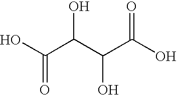 | 168-170 | AI 142 | 154 | 3.02 |
| D-Tartaric | | 168-170 | | | 2.98 |
| Acid | | | | | |
| DL- | | 206 | AI 171 | 185 | |
| Tartaric | | | | | |
| Acid | | | | | |
| Meso- | | 140 | | | 3.22 |
| Tartaric | | | | | |
| Acid | | | | | |
| Succinic Acid | 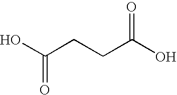 | 188-190 | mp 184 followed by small exo; no TGA step function | 210 | 4.16 |
| Diglycolic Acid | 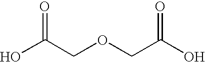 | 142-145 | mp 130 followed by small exo; TGA slow dec. | 155 | 3.28 |
| Malonic Acid | 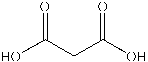 | 135-137 | mp 124 followed by small exo; TGA slow dec. | >250 | 2.83 |
| Trans-Glutaconic Acid | 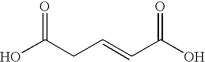 | 137-139 | mp 136; AI 166 | 188 | |
| D-Glutamic Acid | 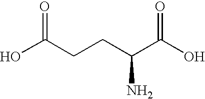 | 200-202 | mp 206; AI 213 | 235 | 2.13 |
| Adipic Acid | 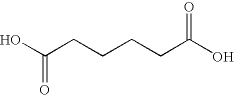 | 152-154 | mp 153; AI 222 | 237 | 4.43 |
| Mucic Acid | 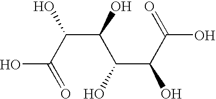 | 215 | AI 200 | 223 | 3.08 |
| Citric Acid | 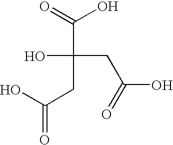 | 152-154 | mp 141 followed by small exo; no TGA step function | >250 | 3.12 |

It will be appreciated that in further accordance with the present invention, gas generators made as known in the art and also vehicle occupant protection systems manufactured as known in the art are also contemplated. As such, autoignition compositions of the present invention are employed in gas generators, seat belt assemblies, and/or vehicle occupant protection systems, all manufactured as known in the art.

In yet another aspect of the invention, the present compositions may be employed within a gas generating system. For example, as schematically shown in FIG. 3, a vehicle occupant protection system made in a known way contains crash sensors in electrical communication with an airbag inflator in the steering wheel, and also with a seatbelt assembly. The gas generating compositions of the present invention may be employed in both subassemblies within the broader vehicle occupant protection system or gas generating system. More specifically, each gas generator employed in the automotive gas generating system may contain a gas generating composition as described herein.

Extrusion aides may be selected from the group including talc, graphite, borazine [(BN)₃], boron nitride, fumed silica, and fumed alumina. The extrusion aid preferably constitutes 0-10% and more preferably constitutes 0-5% of the total composition.

The compositions may be dry or wet mixed using methods known in the art. The various constituents are generally provided in particulate form and mixed to form a uniform mixture with the other gas generant constituents.

It should be noted that all percents given herein are weight percents based on the total weight of the gas generant composition. The chemicals described herein may be supplied by companies such as Aldrich Chemical Company for example.

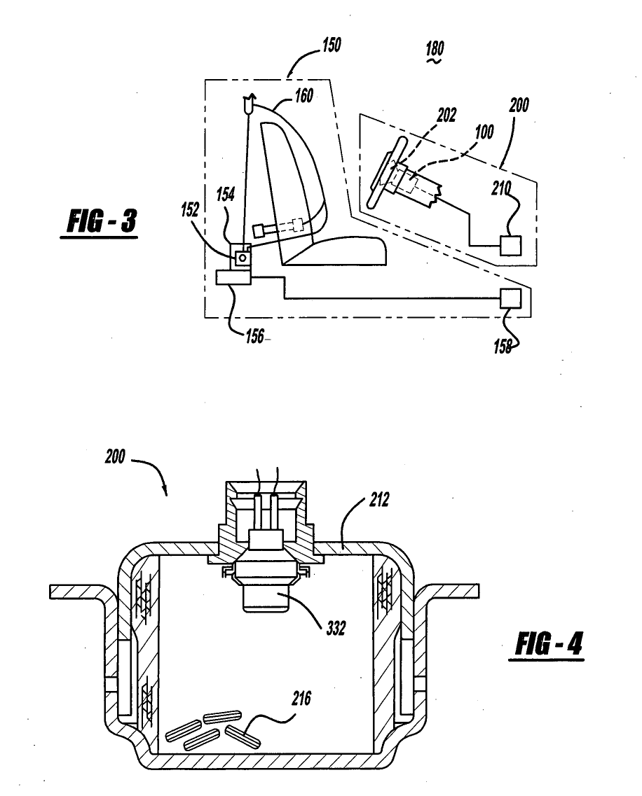

As shown in FIG. 4, another exemplary inflator 200 incorporates a single chamber inflator design for use in a driver side airbag module. In general, an inflator containing a gas generant/booster 216 formed as described herein, may be manufactured as known in the art. U.S. Pat. Nos. 6,422,601, 6,805,377, 6,659,500, 6,749,219, and 6,752,421 exemplify typical airbag inflator designs and are each incorporated herein by reference in their entirety. In accordance with the present invention, the gas generating system 200 does not incorporate a separate booster composition and therefore does not incorporate a booster chamber. As stated previously, the use of a composition that functions as a booster and a gas generant thereby facilitates the simplification of the inflator design.

Referring now to FIG. 3, the exemplary gas generating systems 100, 200 described above may also be incorporated into an airbag system 200. Airbag system 200 includes at least one airbag 202 and a gas generating system 100 containing a gas generant composition (not shown) in accordance with the present invention, coupled to airbag 202 so as to enable fluid communication with an interior of the airbag. Airbag system 200 may also include (or be in communication with) a crash event sensor 210. Crash event sensor 210 includes a known crash sensor algorithm that signals actuation of airbag system 200 via, for example, activation of airbag gas generating system 100 in the event of a collision.

Referring again to FIG. 3, airbag system 200 may also be incorporated into a broader, more comprehensive vehicle occupant restraint system 180 including additional elements such as a safety belt assembly 150. FIG. 3 shows a schematic diagram of one exemplary embodiment of such a restraint system. Safety belt assembly 150 includes a safety belt housing 152 and a safety belt 160 extending from housing 152. A safety belt retractor mechanism 154 (for example, a spring-loaded mechanism) may be coupled to an end portion of the belt. In addition, a safety belt pretensioner 156 may be coupled to belt retractor mechanism 154 to actuate the retractor mechanism in the event of a collision. Typical seat belt retractor mechanisms which may be used in conjunction with the safety belt embodiments of the present invention are described in U.S. Pat. Nos. 5,743,480, 5,553,803, 5,667,161, 5,451,008, 4,558,832 and 4,597,546, each incorporated herein by reference. Illustrative examples of typical pretensioners with which the safety belt embodiments of the present invention may be combined are described in U.S. Pat. Nos. 6,505,790 and 6,419,177, incorporated herein by reference.

Safety belt assembly 150 may also include (or be in communication with) a crash event sensor 158 (for example, an inertia sensor or an accelerometer) including a known crash sensor algorithm that signals actuation of belt pretensioner 156 via, for example, activation of a pyrotechnic igniter (not shown) incorporated into the pretensioner. U.S. Pat. Nos. 6,505,790 and 6,419,177, previously incorporated herein by reference, provide illustrative examples of pretensioners actuated in such a manner.

It should be appreciated that safety belt assembly 150, airbag system 200, and more broadly, vehicle occupant protection system 180 exemplify but do not limit applications of gas generating systems contemplated in accordance with the present invention.

It will be understood that the foregoing description of an embodiment of the present invention is for illustrative purposes only. As such, the various structural and operational features herein disclosed are susceptible to a number of modifications commensurate with the abilities of one of ordinary skill in the art, none of which departs from the scope of the present invention as defined in the appended claims.

What is claimed is:

1. An airbag inflator devoid of a booster chamber.

2. The inflator of claim 1 further comprising a composition including a metal chlorate as a first oxidizer; a primary fuel selected from carboxylic acids, dicarboxylic acids, and mixtures thereof; and a second oxidizer not having perchlorate character.

3. The inflator of claim 2 wherein said metal chlorate is provided at about 10-20 wt %, and said primary fuel is provided at about 15-45 wt %, and said second oxidizer is provided at about 30-50 wt %, said percentages stated by weight of the total composition.

4. The inflator of claim 2 wherein said composition further comprises a secondary fuel selected from tetrazoles, triazoles, furazans, and salts thereof, said secondary fuel provided at about 0.1-30 wt %.

5. A vehicle occupant protection system comprising an inflator in accordance with claim 1.

6. A gas generating system comprising the composition of claim 2.

7. The inflator of claim 2 wherein said primary fuel is selected from tartaric acid and its isomers, succinic acid, glutamic acid, adipic acid, mucic acid, oxalic acid, malonic acid, fumaric acid, galactaric acid, glycolic acid, citric acid, L-malic acid, and mixtures thereof.

8. The composition of claim 4 comprising DL-tartaric acid at about 19-28 wt %, potassium chlorate at about 12-30 wt %, 5-aminotetrazole at about 15-25 wt %, and strontium nitrate at about 30-50 wt %, said percentages stated by weight of the total composition.

9. The composition of claim 2 wherein said secondary oxidizer is selected from metal, basic metal, and nonmetal nitrates, nitrites, oxides, and chlorates.

10. A gas generating system comprising:
a housing devoid of a booster chamber;
a composition including a metal chlorate as a first oxidizer;
a primary fuel selected from carboxylic acids, dicarboxylic acids, and mixtures thereof; and
a second oxidizer not having perchlorate character,
wherein said metal chlorate is provided at about 10-20 wt %, and said primary fuel is provided at about 15-45 wt %, and said second oxidizer is provided at about 30-50 wt %, said percentages stated by weight of the total composition.

11. A gas generator devoid of a booster chamber, the inflator comprising a composition including:
potassium chlorate at about 10-20 wt %
a DL-tartaric acid fuel provided at about 15-45 wt %; and
a secondary oxidizer provided at about 30-50 wt %, said percentages stated by weight of the total composition.

12. The gas generator of claim 11 wherein the composition further comprises:
DL-tartaric acid at about 28.0 wt %;
strontium nitrate at about 32.0 wt %;
potassium chlorate at about 30.0 wt %; and
10% of a secondary fuel.
